(19) United States
(12) Patent Application Publication
(10) Pub. No.: US 2025/0376986 A1
(43) Pub. Date: Dec. 11, 2025

(54) Era Adjustable Ceiling Fan

(71) Applicant: Rose Washington Wilson, Beaumont, TX (US)

(72) Inventor: Rose Washington Wilson, Beaumont, TX (US)

(21) Appl. No.: 19/094,723

(22) Filed: Mar. 28, 2025

Related U.S. Application Data
(60) Provisional application No. 63/572,490, filed on Apr. 1, 2024.

(51) Int. Cl. F04D 27/00; F04D 25/08; F21V 33/00

(52) U.S. Cl. CPC F04D 27/004; F04D 25/088; F21V 33/0096

(57) ABSTRACT

This is ceiling fan system that includes a motor that is removably attached to a battery compartment. The ceiling fan further includes a down rod that is configured to be collapsible. The fan system interfaces with a controller which can remotely control the motor speed, the down rod, and the lighting features.

### BACKGROUND OF THE INVENTION

This invention relates to ceiling fans. Ceiling fans have become very popular to control the flow of air in rooms. Ceiling fan is a fan mounted on the ceiling of a room and is normally electrically powered. Usually, the ceiling fan is hub-mounted with rotating blades to circulate air and cools people effectively by increasing air speed. Unlike air-conditioning, especially when used in conjunction with warmer room air temperature. Additionally, fans use significantly less power than air conditioning. In the winter a ceiling fan can also be used to bring warm air. Many ceiling fan units also double as light fixtures, eliminating the need for separate overhead lights in a room.

Ceiling fans provide a more affordable and energy-efficient alternative to air-conditioning, especially when used in conjunction with warmer room air temperature. Overall, the use of ceiling fans results in a lesser impact on global warming when looking at carbon generation suppression. In addition to improving thermal comfort and reducing energy consumption from air-conditioning, ceiling fans have been studied as a tool that could potentially affect airborne transmission and distribution. This is important, for the risk of aerosol transmission in poorly ventilated places is much higher as proven by cases in hospital wards, restaurants, and offices. According to an experiment using tracer gas it was found that ceiling fans could reduce the exposure risk of the breathing zone by 20%.

Fans increase mixing in a ventilated space, which leads to more homogenous environmental conditions. Moving air is generally preferred over stagnant air, especially in warm or neutral environments, so fans are useful in increasing occupant satisfaction. Because fans do no change air temperature and humidity, but move it around, fans can aid in both the heating and cooling of a space. Because of this, ceiling fans are often an instrumental element of low energy use of the fan system, fans can be an efficient way to improve thermal comfort by allowing for a higher ambient air temperature while keeping occupants comfortable. Fans are an especially economic choice in warm, humid environments.

Ceiling fans can be controlled together in a shared space, and can also be individually controlled in a home or office setting. In an office environment, individually controlled ceiling fans can have a significant positive impact on thermal comfort, which has been shown to increase productivity and satisfaction among occupants. Ceiling fans aid in the distribution of fresh air in both mechanically ventilated and naturally ventilated spaces. In naturally ventilated spaces, ceiling fans are effective at drawing in and circulating fresh outdoor air. In mechanically ventilated spaces, fans can be focused to channel and circulate conditioned air in a room.

### SUMMARY OF THE INVENTION

One of the objectives of this invention is to provide a ceiling fan that can be easily removed for cleaning. The New Era Ceiling Fan comes with an adjustable rod [45] that can be adjusted by remove control or manually. Also, you would be able to lower the adjustable rod [45] shown to at least four feet. The base of the ceiling fan is detachable from the adjustable rod [45]. Also, upon detaching the base of the ceiling fan you would be able to disconnected the wiring which is located inside the battery compartment [50]. This would allow the use of cleaning the fan blades [55], repairs to the motor [35], flywheel [40], change out the battery and light bulbs to the lamp. This would also be a convenience in not having to climb a ladder.

The battery compartment comes with an on and off switch which can be operated from the remote control or manually. Also, the battery compartment has a light indicator which would signify the life of the battery. The green light would indicate that the battery is good. The red light would indicate the battery needs to be replaced. The battery would be designed to last up to two to five years depending on usage. Therefore, there would be no need for a rechargeable battery.

The advantage and purpose of having a battery back up in the new era ceiling fan; if there is a power outage you still have the convenience of air flow and lights.

The house wires would travel inside the down rod (30) which would have an opening on both rods that would lead to an opening inside of the battery compartment (50), which would be connected to the adjustable rod (45), inside the battery compartment (50) is where you can also detach the new era ceiling fan from its wiring and the adjustable rod (45).

Alternatively, any other suitable mounting structures and/or fan systems may be used in conjunction with embodiments described herein. While a variety of fans and fan systems have been made and used, it is believed that no one prior to the inventors has made or used a fan system as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts an exploded view of the fan system of the present invention.

FIG. 2 depicts the remote controller interface to the system.

FIG. 3 depicts an installed system with the adjustable rod.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description explain the principles of the invention; it being understood, however, that this invention is not limited to the precise arrangements shown.

### DETAILED DESCRIPTION OF THE INVENTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

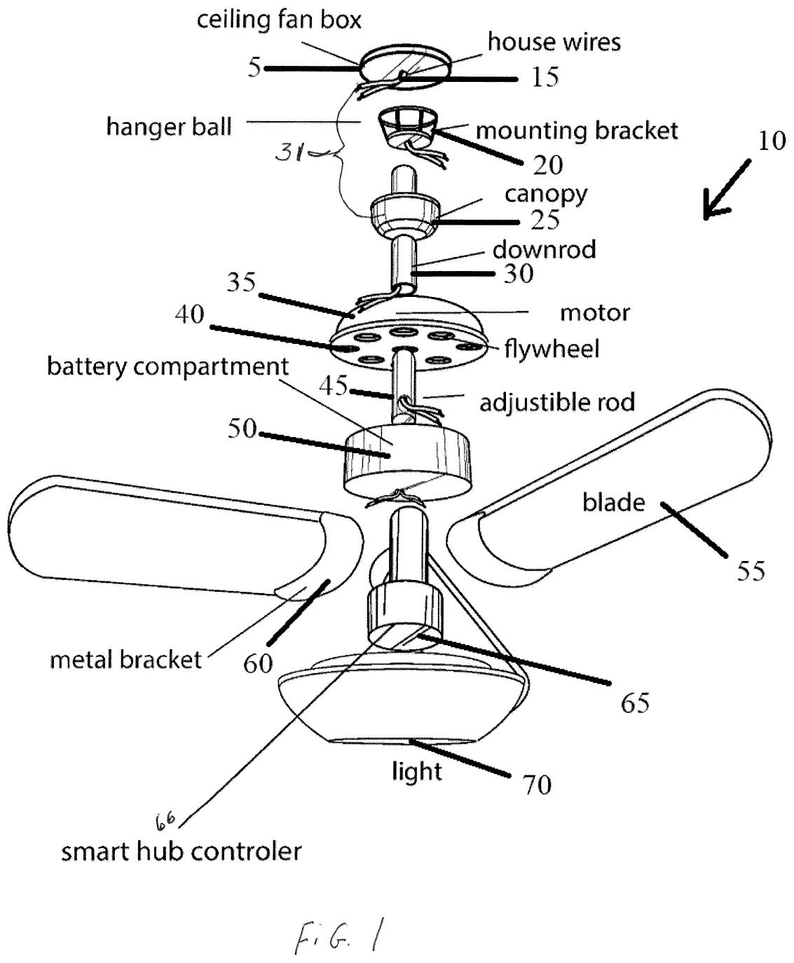

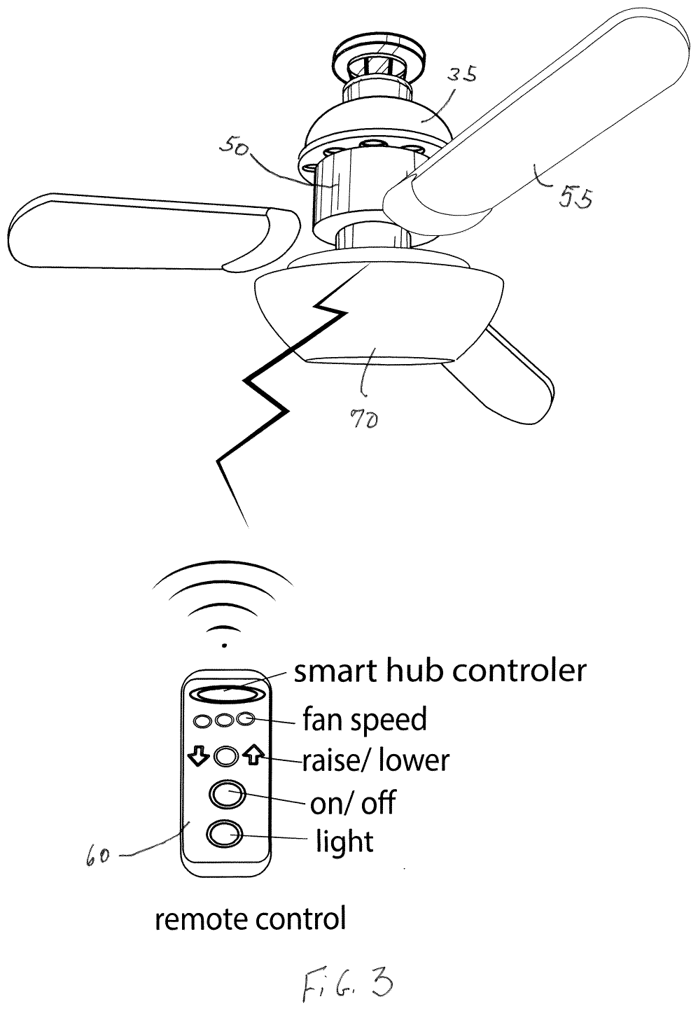

As shown in FIG. 1-3 the fan system (10) of the present invention comprises a mounting assembly (12), downrod (30), motor (35), fan assembly (31), hub controller (65), battery compartment (50), light fixture (70), and a remote control (60).

Each of the foregoing components, among others, will be described in greater detail below, as well as various ways in which fan (10) may be operated. It should be understood, however, that the components described below are mere examples, such components may be varied, modified, substituted, supplemented, or omitted as desired. Various ways in which components described below may be varied, modified, substituted, supplemented, or omitted, as well as ways in which operation of fan (10) may be varied, modified, or supplemented, will be apparent to those of ordinary skill in the art in view of the teachings herein.

The mounting assembly (20) secures the fan system (10) to the ceiling and comprises a canopy (25), mounting bracket (20), hanger ball (75), and ceiling fan box (5). Mounting system (20) in this example using a ball and socket system, but alternative mounting systems can be configured to be used with the fan system (10).

With this system, there is a metal or plastic hemisphere (i.e. hanger ball (75)) mounted atop downrod (30); this hemisphere rests in a ceiling mounting bracket (20) encompassed by self-supporting canopy (25). Once properly installed, the mounting assembly (20) allows the fan system (10) to move freely. Ceiling fan box (5) receives the canopy (25) to secure the fan system (10) to the ceiling. The canopy (25) encompasses the mounting bracket (20) which is configured to receive the electrical house wires (15) and hanger ball (75).

The house wires can travel inside the down rod (30) which would have an opening that would lead to an opening inside of the battery compartment (50), which would be connected to the down rod (30). Inside the battery compartment is where you can also detach the fan system (10) from the down rod (30).

As illustrated when a canopy (25) mounting system is used, the canopy (25) is mounted either directly or indirectly to the mounting bracket (20). The downrod (30) is then placed within the slotted opening (30) of the canopy (25) and is slid to the center of the canopy (25) which is configured to accept and retain the downrod (30) and the ball joint (75). Thus, the weight of the ceiling fan system (10) is supported by the canopy (25) through the ball joint (75). Working through the slotted opening (30) in the canopy (25), the housing wires (15) in the ceiling are electrically connected to the motor (35) of the fan system (10) within the ceiling fan assembly (31) to the electrical wires within the ceiling. Canopy (25) has a cover that is mounted to the mounting assembly (20) wherein complete the canopy system is formed.

Down rod (30) is normally made of a hollow metal pipe that is used to suspend the fan system (10) from the ceiling. Down rod (30) can come in various lengths and widths, depending on the fan type.

Fan assembly comprises fly wheel (40), the fan blades (55), and blade mounting members (50). Fan blades (55) may be secured to mounting members (42) using any suitable structures or techniques, including but not limited to one or more bolts or other fasteners. The fan system (10) may include blade retention components that are configured to retain blades (50). In particular, several retainer members may be joined relative to each blade (50) using bolts or any other suitable fasteners. Retainer members are configured to provide a safety feature for fan system (10). In particular, each retainer member is joined to two adjacent mounting members (42) and two adjacent fan blades (50), as will be described in greater detail below. In the event that a fan blade (50) breaks free of its mounting member (42), the retainer members that are secured to that fan blade (50) may prevent the fan blade (50) from falling to the ground or otherwise flying free of fan system (10). Similarly, if a mounting member (42) breaks free from hub (40), the retainer members (300) that are secured to that mounting member (42) will prevent the mounting member (42) (and the fan blade (50) that is coupled with that mounting member (42)) from falling to the ground or otherwise flying free of fan system (10)

The fan assembly (31) can comprise One to six paddles (called “blades”) which are usually made of wood, plywood, steel, aluminum, MDF, metal, or plastic. The present invention preferably would comprise 3 blades. The fan assembly (31) can be mounted under, on top of, or on the side of the motor (35).

Metal arms which is also called blade irons can also alternately be called blade brackets, blade arms, blade holders, or flanges. The metal arms connect the blades to the motor (35).

Motor is preferably an electric motor. Motor would have three adjustable speed levels-Assorted switches used for turning the fan on and off, adjusting the speed at which the blades rotate, changing the direction in which the blades rotate, and operating any lamps that may be present. Some fans have remote controls to adjust speed and turn the light off and on. Specifically the unshown electric wires associated with the electric motor, is then wired to the electrical wires in the ceiling

Flywheel-a metal, plastic, or tough rubber double-torus that is attached to the motor shaft and to which the blade irons may be attached. The flywheel inner ring is locked to the shaft by a lock-screw and the blade irons to the outer ring by screws or bolts that feed into tapped metal inserts. Rubber or plastic flywheels may become brittle and break, a common cause of fan failure. Replacing the flywheel may require disconnecting wiring and requires removing the switch housing that's on the way for the flywheel to be removed and replaced.

Battery compartment contains a rechargeable battery that support the fan system (10) when the electricity is out or alternatively if the user decides to switch to the battery system.

The present invention preferably uses lithium-ion (Li-ion) batteries which are the predominant commercial form of rechargeable battery (37), widely used in portable electronics and electrified transportation. The lithium battery is stored and electrically connected within the battery compartment. When the power is voluntarily or involuntarily disconnected, the electrical circuit is transferred to the battery.

In the illustrated embodiment, lighting fixture (70) can be installed to the motor (35) which is installed within a housing. In use, the lighting fixture (70) projects light up onto the ceiling or for aesthetic reasons (to “create ambience”). Downlights, often referred to as a “light kit”, can add ambient light to a room and can be used to replace any ceiling-mounted lamps that were displaced by a installation of a ceiling fan. Decorative lights can also be mounted inside the motor housing, and in this type of setup, the motor housing side-band often has glass or acrylic panel sections, which allow light to shine through.

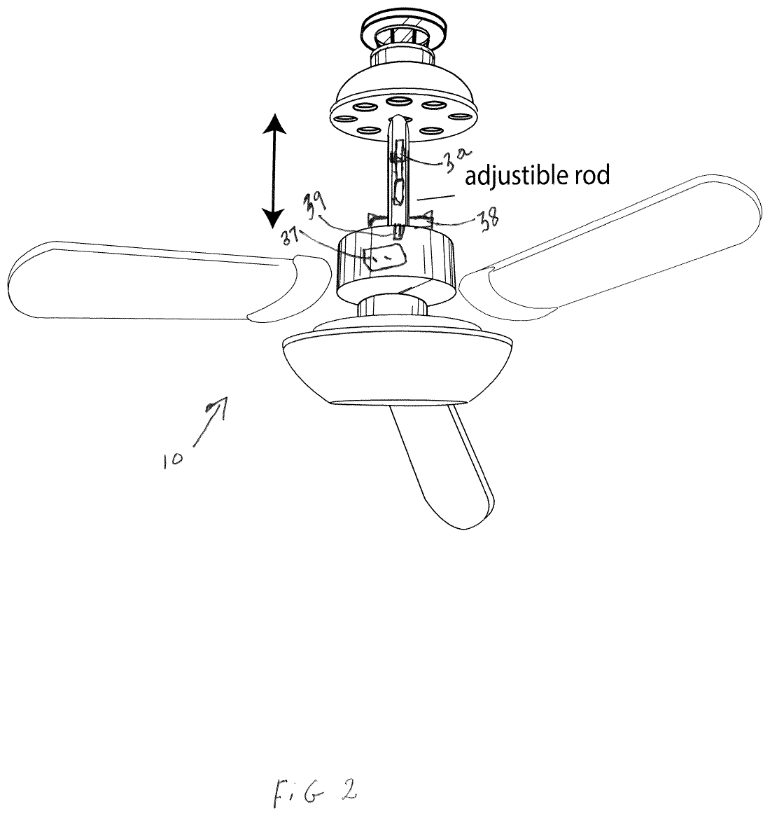

FIG. 2 depicts, a cut away view of the remote-control system of the present invention. The remote control (60) designed for use with ceiling fan (10) contains a remote transmitter (62) which sends a signal to a receiver (64) in the ceiling fan system (10) that transmits simple programmed instructions through a controller (66) which is a simple computer that can be programmed to control the speed of the motor.

The controller is a simple computer that is electronically interfaced with the motor, battery system, and the lighting fixture.

The remote control (60) can electronically provide instructions to
turn on/off the fan
turn on/off the light
adjust the speed of the motor which controls the rotation of the fan bladed
adjust the brightness of the light switching between the battery and electrical power.

In alternative embodiments the down rod (30) is configured to collapse. In an alternative, as depicted the down rod (30) is segmented into a plurality of sections (32) with each lower section having a smaller diameter than the upper section. With this configuration the down rod (30) collapses when in use. To disconnect the fan system down rod is detached which allows the down rod to extend downwardly and be disconnected. At the lower end of the down rod is configured with a connector member (39) that securely interlocks and electrically attaches to the battery compartment. The connector member is configured to be secured to prevent the fan system from detaching and falling during use.

Alternatively, the down rod (30) can be disposed atop an electric pump that controls the extension and collapsing of the down rod (30). The electric pump (38) would be configured to disconnect the down rod (30) from the battery compartment and then automatically extend downwardly thereby extending the down rod (30) and allowing the user to disconnect the fan system. To reconnect, the user would reconnect the down road and allow the pump to push upward thereby collapsing the down rod (30).

What is claimed:

1. A ceiling fan system (10) of the present invention comprises a mounting assembly (12), downrod (30), motor (35), fan assembly (31), hub controller (65), battery compartment (50), light fixture (70), and a remote control (60).

2. The ceiling fan system of claim 1 wherein the down rod is configured to be adjustable.

3. The ceiling fan system of claim 1 wherein the fan assembly is detachable.

4. The ceiling fan system of claim 1 further comprising:
a controller electronically programmed to
(a) Turn on/off motor; and
(b) Adjust speed of the motor.

5. The ceiling fan system of claim 1 further comprising a lighting fixture configured to operationally connected to the fan assembly.

6. The ceiling fan system further comprises a remote control configured to operationally interface with the controller.
